(19) United States
(12) Patent Application Publication
(10) Pub. No.: US 2006/0000596 A1
(43) Pub. Date: Jan. 5, 2006

(54) Multi-zone temperature control system

(75) Inventors: Bruce Kranz, Farmington, MN (US); Dan Hotchkiss, Burnsville, MN (US); Kim C. Kolstad, Lonsdale, MN (US)

Correspondence Address: MICHAEL BEST & FRIEDRICH, LLP, 100 E WISCONSIN AVENUE, MILWAUKEE, WI, 53202, US

(73) Assignee: Thermo King Corporation, Minneapolis, MN (US)

(21) Appl. No.: 11/219,969

(22) Filed: Sep. 6, 2005

Related U.S. Application Data
(63) Continuation of application No. 10/284,883, filed on Oct. 31, 2002.

(51) Int. Cl. B60H 3/00; F25B 29/00; B60H 1/00; G05D 23/00; G05D 15/00; B61D 27/00; G05D 16/00

(52) U.S. Cl. 165/203; 165/202; 165/279; 165/42; 165/61

(57) ABSTRACT

The invention recites a multi-zone temperature control system operable to control the temperature within a plurality of compartments. The system includes a scroll compressor operable at a speed to compress a flow of fluid and a condenser, operable to cool the flow of fluid. The system also includes a plurality of heat exchangers. Each heat exchanger is associated with one of the plurality of compartments and is operable to maintain the temperature of the compartment within a desired range. A plurality of valves are operable to direct and vary the amount of the flow of fluid from the compressor to the condenser and the plurality of heat exchangers. The valves are configurable to allow each of the heat exchangers to heat or cool their associated compartment. The system also includes a controller operable to control the valves to maintain the temperature of each compartment within its desired range.

### BACKGROUND OF THE INVENTION

The present invention relates to temperature control systems, and particularly to multi-zone temperature control systems. More particularly, the present invention relates to multi-zone temperature control systems for movable compartments.

Refrigeration systems are commonly employed to cool compartments such as truck trailers, cargo containers, and the like. These systems are well suited to maintaining the compartment temperature below a predetermined value.

In some applications, it is desirable to maintain the temperature of the compartment within a predefined range rather than below a maximum temperature. These systems often include a second heat exchanger or second flow path adapted to heat the compartment. A refrigeration system such as a vapor-compression cycle or cryogenic cycle cools the compartment using one heat exchanger or flow path, while a heating cycle operates to heat the compartment using the second heat exchanger or flow path. Many applications use engine coolant as the heat source.

In another application, it is desirable to maintain the temperature of two or more compartments or zones within two or more different ranges. Often, two separate refrigeration cycles are employed including two separate compressors and condensers. Alternatively, a single compressor is used. However, the complexity of the system limits the choice of compressors. Additionally, a second cycle is required if heating of one or more of the compartments is needed.

### SUMMARY OF THE PREFERRED EMBODIMENTS

Accordingly, the present invention provides a dual-zone temperature control system operable to control the temperature in a first and second compartment. The system includes a compressor operable to compress a flow of fluid and first and second heat exchangers each of which is operable to control the temperature within one of the first and second compartments. The first heat exchanger is positioned adjacent the first compartment and the second heat exchanger is positioned adjacent the second compartment. A condenser selectively receives the flow of fluid and is operable to cool the flow of fluid. The system also includes a flow control system that is operable to selectively direct the flow of fluid to the condenser or to bypass the condenser such that the first and second heat exchangers operate to maintain their respective compartments within a first and second temperature range.

In another embodiment, the invention provides a multi-zone temperature control system operable to control the temperature within a plurality of compartments. The system includes a compressor operable at a speed to compress a flow of fluid and a condenser, operable to cool the flow of fluid. The system also includes a plurality of heat exchangers. Each heat exchanger is associated with one of the plurality of compartments and is operable to maintain the temperature of the compartment within a desired range. A plurality of valves are operable to direct and vary the amount of the flow of fluid from the compressor to the condenser and the plurality of heat exchangers. The valves are configurable to allow each of the heat exchangers to heat or cool their associated compartment. The system also includes a controller operable to control the valves to maintain the temperature of each compartment within its desired range.

In yet another embodiment, the invention provides a method of maintaining the temperature in a plurality of compartments, each compartment having a desired temperature range. The method includes operating the compressor at a speed to compress and heat a flow of fluid and determining which compartments require heating, cooling, or are within their desired temperature range. The method further includes directing the flow of fluid from the compressor to heat exchangers associated with compartments that require heat and using the heat of compression to heat the compartments and condense the flow of fluid. The method also includes directing the flow of fluid from the heat exchangers that are heating their respective compartments to heat exchangers of compartments that require cooling.

Additional features and advantages will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is a schematic representation of a dual-zone temperature control system embodying the present invention;

FIG. 2 is a schematic representation of the system of FIG. 1 configured to provide cooling to both zones;

FIG. 3 is a schematic representation of the system of FIG. 1 configured to provide cooling to one zone and heating to the other zone;

FIG. 4 is a schematic representation of the system of FIG. 1 configured to provide heating to both zones;

FIG. 5 is a schematic representation of the system of FIG. 1 configured to provide cooling to one zone while the second zone is providing neither heating nor cooling;

FIG. 6 is a schematic representation of the system of FIG. 1 configured to provide heating to one zone while the second zone is providing neither heating nor cooling.

### DETAILED DESCRIPTION OF THE DRAWINGS

Before describing the figures in detail, it should be noted that the figures illustrate a dual-zone temperature control system 10 for the sake of simplicity. However, the invention is envisioned as operating with a plurality of zones with the only limit being the flow capacity of the compressor. Therefore, while the invention will be described in detail as it relates to the dual-zone system 10 illustrated, the invention should not be limited to two-zone systems.

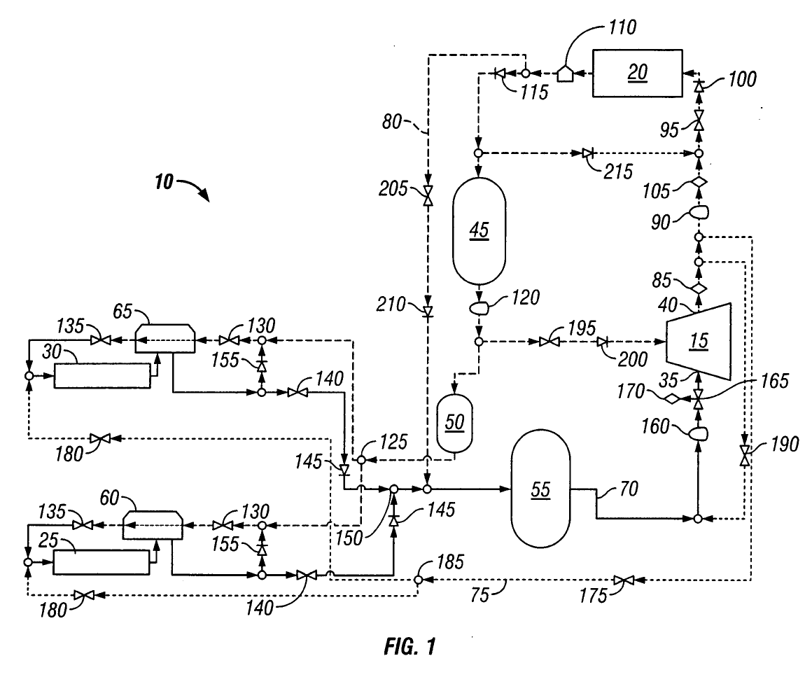

The system 10 as illustrated in FIG. 1 includes a controller (not shown), a compressor 15, a condenser 20, two heat exchangers such as the first evaporator 25 and the second evaporator 30, and a plurality of valves and pipes interconnecting the aforementioned components. It is envisioned that the system 10 will be most useful with mobile storage compartments in which temperature control is needed, such as a truck trailers, cargo container, train cars and the like. However, the present invention should not be limited to applications involving temperature control of moving compartments, as it will function to control the temperature within stationary compartments as well.

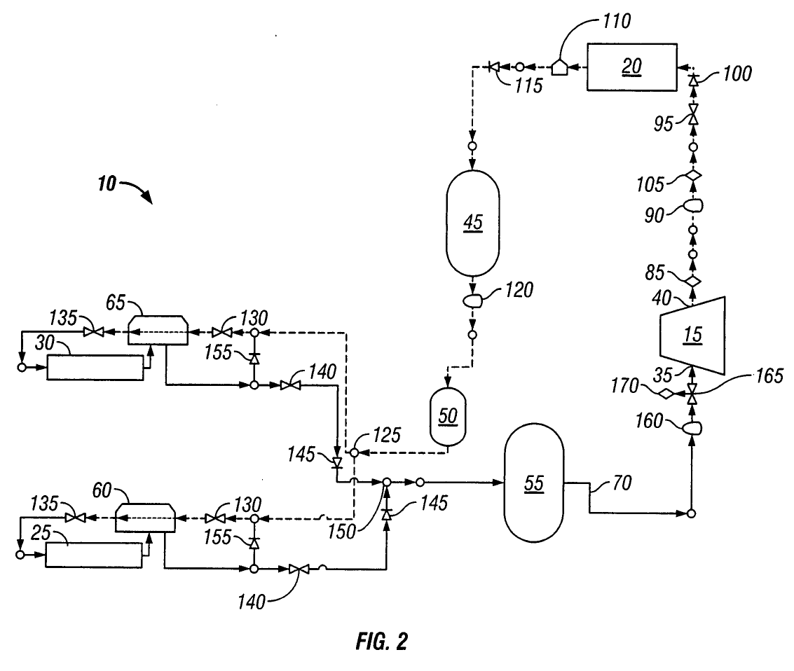

The controller is a micro-processor based programmable control that receives inputs from various sensors located throughout the system (e.g., pressure transducers, thermocouples, thermistors, RTD's, flow meters, pressure switches, etc.). The controller uses the inputs and the information programmed into the controller to determine how to configure the system 10. Generally, each evaporator 25, 30 may be operated in one of several modes including, heating mode wherein the evaporators 25, 30 operate as heat exchangers and heat their respective compartments, cooling mode wherein the evaporators 25, 30 operate as evaporators and cool their respective compartments, inverted heating wherein one or more of the evaporators 25, 30 operate as condensers while the remaining evaporators 25, 30 operate as evaporators, and null mode wherein there is no flow through the evaporator 25, 30. The actual configuration of the system will be discussed in detail below with regard to FIGS. 2-6.

The condenser 20 is a heat exchanger adapted for the exchange of heat between compressed refrigerant and air. The refrigerant generally flows within the tubes of a fin-tube type heat exchanger as air is forced across the fins. The refrigerant is cooled and condenses within the condenser 20. In most constructions, fans move the air across the fins of the condenser 20. However, other constructions may rely on natural airflow through the condenser 20. For example, systems installed on moving vehicles can direct the moving air stream generated by the movement of the vehicle through the condenser 20.

The compressor 15 operates to draw in refrigerant at an inlet 35 and discharge the refrigerant at an outlet 40. While many types of compressors 15 will operate with the system (e.g., reciprocating, screw, centrifugal, etc.) the preferred compressor is a scroll compressor. One such compressor is Model Number TF22KL2E-42C marketed by Copeland Corporation of Sidney, Ohio. Scroll compressors are more efficient then reciprocating compressors and generally have fewer moving parts.

An engine or motor (not shown) drives the compressor 15 at a desired speed to compress the refrigerant. In constructions that are cooling compartments within moving vehicles, the vehicle engine itself is typically used to power the compressor 15. The compressor 15 can be directly or indirectly connected to the engine. In another construction, the engine powers an alternator that in turn drives an electric motor that is coupled to the compressor 15. The controller determines the desired speed of the compressor 15 and adjusts the motor or engine to achieve that speed.

The evaporators 25, 30 are similar to the condenser 20. Refrigerant flows through the tubes of the evaporators 25, 30, while air from the temperature-controlled compartment is forced over the fins of the evaporators 25, 30. Variable speed fans disposed adjacent each of the evaporators 25, 30 operate to move compartment air through their respective evaporators 25, 30. The fans are powered by variable speed electric motors to allow the controller to vary the mass flow rate of compartment air through the air side of the evaporators 25, 30. In another construction, single speed fans are employed. The controller pulses the fans on and off to control the mass flow rate of compartment air through the evaporators 25, 30.

Also included in the system 10 of FIG. 1 are a receiver tank 45, a dryer 50, an accumulator 55, and two additional heat exchangers 60, 65. The receiver tank 45 is positioned downstream of the condenser 20. The receiver tank 45 receives and stores refrigerant when the system 10 is operating in a configuration in which a full charge of refrigerant is not required. In addition, the receiver tank 45 acts to remove any bubbles (e.g., air) entrained in the flow of liquid refrigerant.

The dryer 50 receives a flow of liquid refrigerant from the receiver tank 45 and filters out any particles entrained in the flow. In addition, the dryer 50 absorbs any moisture trapped within the refrigerant flow.

The accumulator tank 55 is disposed in the suction line upstream of the compressor 15. The accumulator tank 55 receives the flow of used refrigerant and assures that no liquid refrigerant passes to the compressor inlet 35. During transient operation (i.e., transitioning between operating modes) liquid refrigerant may surge into the accumulator tank 55. The accumulator tank 55 provides sufficient volume to allow the refrigerant to boil off before entering the compressor 15.

In addition to the evaporators 25, 30, each compartment also includes one of the additional heat exchangers 60, 65 or second heat exchanger. The second heat exchangers 60, 65 are used when the particular compartment is in the cool mode to improve the overall performance of the system. The second heat exchangers 60, 65 are plate heat exchangers having a liquid refrigerant flow path on one side of the plate and a suction or vapor flow path on the second side. The second heat exchangers 60, 65 improve system performance by pre-cooling the liquid refrigerant before it enters the evaporator 25, 30. When the refrigerant exits the condenser 20, it is no cooler than the ambient air that passes through the condenser 20. When the refrigerant exits the evaporators 25, 30 it is typically cooler than the liquid refrigerant exiting the condenser 20, thereby allowing it to pre-cool the refrigerant in the second heat exchangers 60, 65.

The remaining components in the system 10 comprise valves, transducers, solenoids, switches, or regulators and will be described in conjunction with the operation of the system 10 and FIGS. 2-6.

Turning to FIG. 2, the system 10 is illustrated in a cool/cool mode. To arrive at this configuration, the controller determined that the temperature within each compartment is above a predetermined level, thus requiring cooling. The temperature measurements can be made using any suitable method with resistance type sensors (e.g., thermistor or RTD) being preferred. Other constructions may use temperature switches or other measuring devices (e.g., thermistors, infrared detectors, resistance temperature detectors (RTD), etc.).

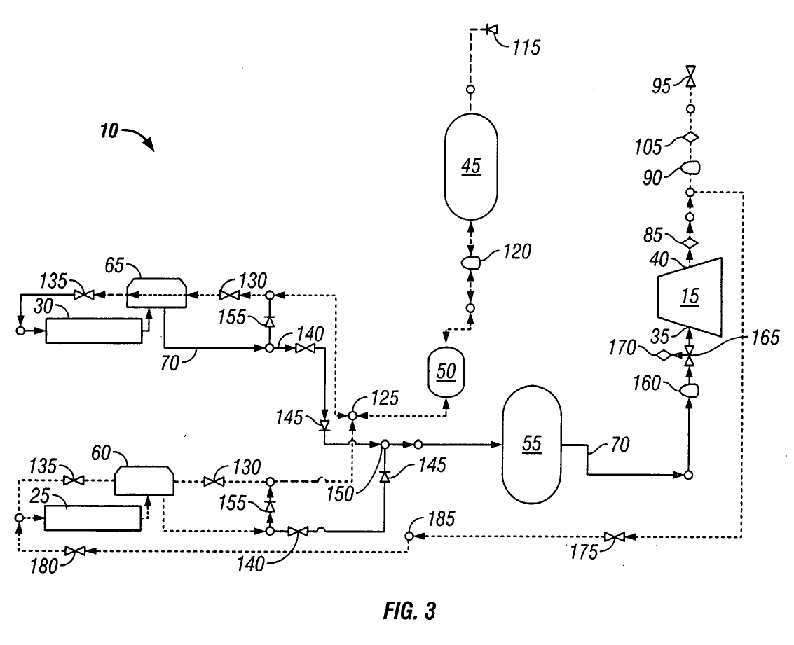

In FIGS. 2-6, suction lines 70 are shown solid, hot gas lines 75 are shown dotted, and liquid lines 80 are shown dashed. Also, any components that are isolated and receive no flow are omitted from the figures for clarity. For example, when in the heat/cool mode illustrated in FIG. 3, the condenser 20 is not used and is thus omitted from the drawing. It should be understood that the component remains in place no matter the mode of operation.

Returning to FIG. 2, operation of the compressor 15 produces a flow of high-pressure refrigerant. The act of compression also produces significant heating, resulting in a flow of hot refrigerant. A discharge pressure transducer 85 (DIS) measures the discharge or outlet pressure of the compressor 15. A diaphragm and strain gage type pressure transducer is used in the illustrated construction with other pressure measuring devices also functioning with the invention (e.g., capacitance pressure transducers, potentiometric pressure sensors, resonant-wire sensors, etc.).

The hot refrigerant also flows through a Schrader valve 90, a condenser inlet solenoid 95, and a condenser inlet check valve 100. The Schrader valve 90 provides a convenient port for charging (adding refrigerant) to the system 10 and is not necessary for the performance of the system 10.

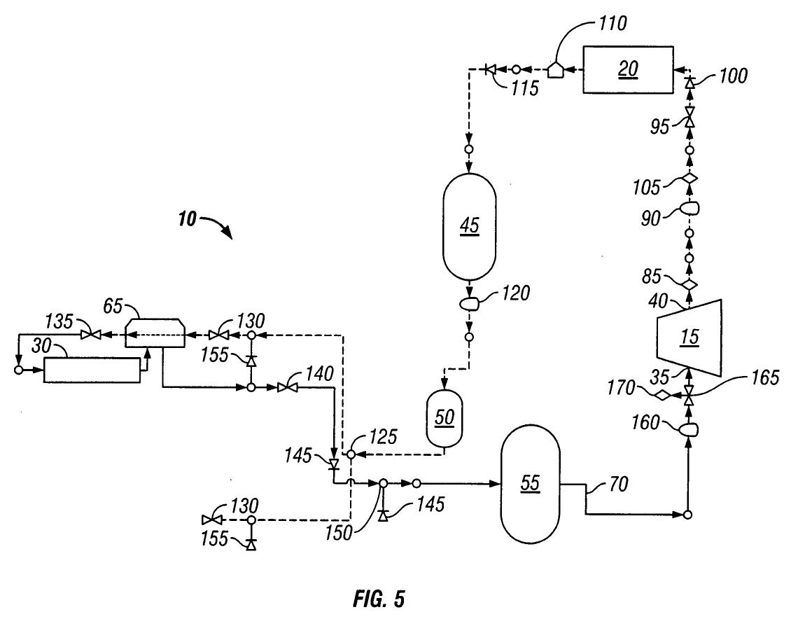

The condenser inlet solenoid 95 (CIS) closes to prevent refrigerant flow to the condenser 20. In the cool/cool mode illustrated in FIG. 2 and the cool/null mode illustrated in FIG. 5 the CIS valve 95 is open, thereby allowing refrigerant flow through the condenser 20. In the remaining modes, illustrated in FIGS. 3-4 and 6, the CIS 95 is closed and no flow passes into the condenser 20 from the compressor 15.

The condenser inlet check valve 100 (CICV) prevents fluid flow from the condenser 20 toward the compressor 15.

A high-pressure cut-out switch 105 (HPCO switch) is disposed in the flow path between the compressor 15 and the condenser 20. The HPCO switch 105 measures the pressure of the hot refrigerant exiting the compressor 15. If the HPCO switch 105 detects a pressure in excess of a predetermined value, it will act to shut down the system 10. The HPCO switch 105 is hard-wired directly into the system power supply to allow it to act independent of the controller to shut down the system 10. In other constructions, the HPCO switch 105 sends a signal to the controller and the controller initiates a system shut down. In the construction illustrated herein, the pressure at which the HPCO switch 105 initiates a shut down is 450 PSIG with higher or lower pressures being possible.

The hot refrigerant flows through the condenser 20 and is condensed to produce a flow of cool liquid refrigerant. The flow of liquid refrigerant passes through a relief valve 110 and a condenser check valve 115 before entering the receiver tank 45. The relief valve 110 operates to vent refrigerant to the atmosphere. The relief valve 110 opens to protect system components from damage when the internal system pressure exceeds a predetermined value. In preferred constructions, the relief valve 110 is set to open when the pressure reaches 500 PSIG or higher. With higher and lower settings being possible depending on the specific system components being used.

The condenser check valve 115 is positioned to prevent refrigerant flow from passing in a reverse flow direction (from the receiver tank 45 to the condenser 20) when operating in modes in which the condenser 20 is not used (heat/cool, heat/heat, and heat/null).

The flow exits the receiver tank 45, passes through a receiver tank service valve 120 (RTSV), and passes through the dryer 50 to a distribution manifold 125. The RTSV 120 is a valve that can be closed manually to service the system 10 and is not necessary for system function. In addition, the valve 120 includes a charging port that may be used to add or remove refrigerant from the system 10.

At the distribution manifold 125, the flow splits and flows toward the two compartments. Because both flows are identical, only one flow will be described. It should also be noted that in systems having more than two compartments, more flows would exit the distribution manifold 125.

From the distribution manifold 125, the flow passes through a liquid line solenoid (LLS) 130, the second heat exchanger 60, and a thermal expansion valve (TXV) 135. The LLS 130 opens to allow liquid refrigerant to flow to the evaporator 25 when in cooling mode. In addition, the LLS 130 allows refrigerant to bleed to and from the receiver tank 45 as conditions require during other operating modes.

The thermal expansion valve 135 meters refrigerant to the evaporator 25 to maximize cooling capacity. The TXV 135 also includes a bleed port that allows refrigerant to flow to and from the receiver tank 45 when the evaporator 25 is operating in a mode other than cooling.

The inlet to the TXV 135 is a high-pressure region, while the outlet is a low-pressure region. Thus, the refrigerant at the inlet is a liquid, while the refrigerant on the outlet side has either completely, or partially evaporated and is a vapor or a vapor-liquid mix. The process of flowing through the TXV 135 reduces the temperature of the refrigerant. Thus, the exit of the TXV 135 is the lowest temperature point in the cycle.

After passing through the TXV 135 the low-pressure refrigerant passes through the evaporator 25, the second heat exchanger 60, a suction line solenoid 140 (SLS), and a suction line check valve 145 (SLCV) before it is collected at a vapor collection manifold 150.

The SLS 140 is a control valve that remains open during cooling to allow the free passage of refrigerant therethrough. The SLS 140 closes during inverted heating to redirect refrigerant through a liquid return check valve 155 (LRCV) which will be discussed with reference to FIG. 3.

The suction line check valve 145 (SLCV) prevents reverse flow in the suction line and reduces the amount of liquid refrigerant that pools in the suction line during inverted heating.

From the SLCV 145, the low-pressure refrigerant flows to the collection manifold 150 where refrigerant from the other compartments that are operating in a similar mode collects. From the collection manifold 150, the flow proceeds through the accumulator tank 55, a suction service valve 160, and a mechanical throttle valve 165 before returning to the compressor 15 at the compressor inlet 35. The suction service valve 160 (SSV) is a manually actuated valve that isolates the system 10 during maintenance and is not necessary for system function. The SSV 160 remains open during all normal operating modes.

The mechanical throttle valve 165 (MTV) restricts the pressure of the refrigerant at the compressor inlet 35. The MTV 165 is set at a predetermined position to prevent overloading the compressor 15 or the prime mover driving the compressor 15. A suction pressure transducer 170 (SUC) measures the suction or inlet pressure at the compressor 15. A diaphragm and strain gage type pressure transducer is used in the illustrated construction with other pressure measuring devices also functioning with the invention (e.g., capacitance pressure transducers, potentiometric pressure sensors, resonant-wire sensors, etc.). After exiting the MTV 165, the flow reenters the compressor 15 and the cycle continues.

Turning to FIG. 3, the system 10 is illustrated with one compartment operating in inverted heating mode and the second compartment in cooling mode. When operating as illustrated in FIG. 3, the controller closes the condenser inlet solenoid 95 (CIS) to prevent refrigerant flow into the condenser 20. Instead, the high-pressure refrigerant flow passes through the discharge pressure transducer 85, a discharge pressure regulator 175 (DPR), and a hot gas solenoid 180 (HGS) before entering the evaporator 25 in the compartment being heated.

The discharge pressure regulator 175 (DPR) increases the discharge pressure of the compressor 15 during heating or inverted heating, thereby increasing the discharge temperature to improve the heating capacity of the flow of refrigerant. The DPR acts as a controllable flow restriction downstream of the compressor 15. The flow restriction acts to resist the flow of refrigerant and increase the discharge pressure of the scroll compressor 15. Without the DPR, the scroll compressor 15 would simply move the refrigerant through the system 10 without adding significant heat.

The hot gas solenoid 180 (HGS) opens to allow flow from the compressor 15 to the evaporator 25 to heat the compartment. When in cooling mode, the HGS 180 closes to prevent flow of hot gas from the compressor 15 to the evaporator 25.

The high-pressure vapor exits the HGS 180 and flows through the evaporator 25. The vapor condenses to form a flow of high-pressure liquid that exits the evaporator 25 and flows through the second heat exchanger 60. The air flowing through the evaporator 25 is heated by the flow of hot refrigerant, thereby heating the compartment. The liquid exits the second heat exchanger 60 and passes through the liquid return check valve 155 (LRCV) to the distribution manifold 125. The LRCV 155 prevents reverse flow of high-pressure liquid when in cooling mode and allows the flow of high-pressure liquid when the SLS 140 is closed and the compartment is operating in heating mode as illustrated in FIG. 3.

From the distribution manifold 125, the cycle is identical to that described above with regard to FIG. 2. In addition, excess refrigerant is free to flow into the dryer 50 and to the receiver tank 45 from the distribution manifold 125. Alternatively, if additional refrigerant is required, it can flow from the receiver tank 45 through the dryer 50 and into the distribution manifold 125. Thus, the first evaporator 25 operates as a condenser and heats its respective compartment using the heat generated by the compressor 15, while the second evaporator 30 cools the second compartment in the manner described above with regard to FIG. 1.

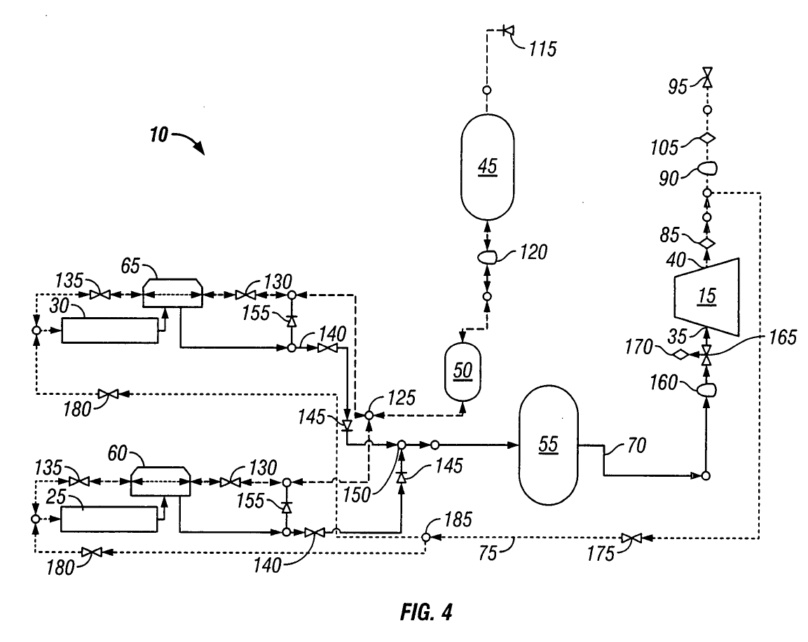

With reference to FIG. 4, the system 10 is illustrated in heat/heat mode. Both compartments are calling for heat and the controller has configured the system to provide heat substantially as described above with regard to FIG. 3. The flow of hot high-pressure refrigerant exits the compressor 15 and flows through the DPR 175 to a distribution node 185 where the flow is distributed to the different compartments requiring heat. From the distribution node 185, each flow passes through one of the hot gas solenoids 180 before entering one of the evaporators 25, 30. Once the flow exits the evaporators 25, 30, it follows a path that is similar to that described above with regard to FIG. 2.

The condenser check valve 115 prevents flow from the receiver tank 45 into the condenser 20 during operation. However, excess refrigerant can flow to the receiver tank 45 from the inlet of the evaporator 25, 30 through the thermal expansion valve 135. Alternatively, additional refrigerant can flow from the receiver tank 45 through the thermal expansion valve 135 and into the evaporator 25, 30 as needed by the system 10.

Turning to FIG. 5, the system is illustrated in cool/null mode. In this mode, one of the compartments is being cooled, while the other compartment is within its desired temperature range and thus requires no heating or cooling. In this mode, the refrigerant follows the path described above with regard to FIG. 2 through only one of the evaporators 30. The liquid line solenoid 130 and hot gas solenoid 180 of the second compartment are closed to isolate the evaporator 25 from the system 10. Thus, the system 10 is able to cool only one of the compartments if necessary.

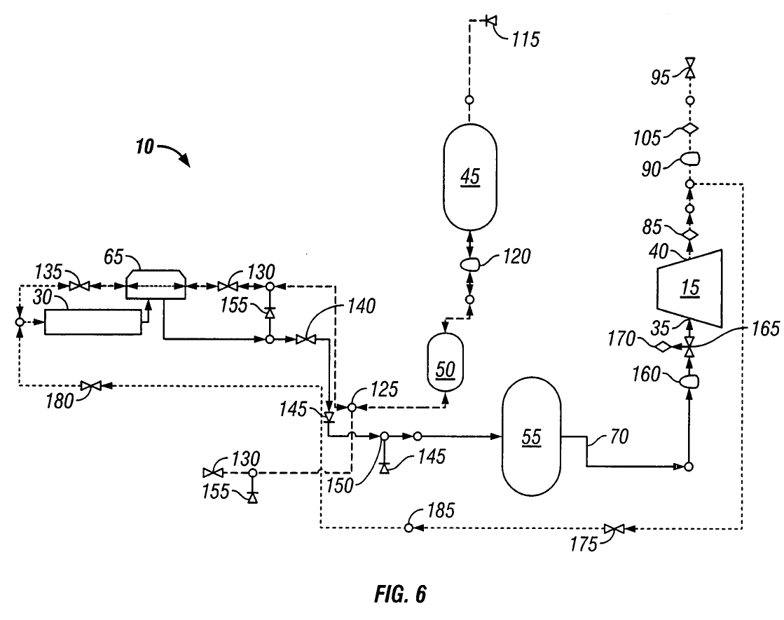

FIG. 6 illustrates the system 10 configured in heat/null mode. Like the configuration of FIG. 5, one of the compartments is operating to control temperature, while the second compartment is idle. The flow through the compartment being heated is similar to that described above with regard to FIG. 4. The liquid line solenoid 130 and hot gas solenoid 180 of the second compartment are closed to isolate the evaporator 25 from the system 10. Thus, the system 10 is able to heat one compartment, while the second compartment remains idle.

Returning to FIG. 1, several flow paths are illustrated that function not to heat or cool a compartment but rather to protect the system 10 from conditions that may cause damage to system components or may prevent the system 10 from operating properly.

The controller monitors the pressure ratio between the compressor outlet 40 and the compressor inlet 35. The pressure values are transmitted by the discharge pressure transducer 85 and the suction pressure transducer 170 to the controller. If the pressure ratio exceeds a predetermined value, a hot gas bypass solenoid 190 (HGBS) opens to reduce the pressure ratio. Alternatively, the HGBS 190 is opened when a suction pressure is detected that is below a predetermined value, regardless of the measured pressure ratio.

The HGBS 190 is an orificed solenoid that controls the flow through a high-pressure line that interconnects the compressor outlet 40 with the compressor inlet 35 as illustrated in FIG. 1. When open, high-pressure gas flows back into the low-pressure flow path, thereby increasing the suction pressure at the compressor inlet 35. The hot gas bypass protects the compressor 15 from damage caused by operating at an excessively high-pressure ratio or operating with a suction pressure that is too low.

A second compressor protection system protects the compressor 15 from excessive heating. The system 10 routes cool refrigerant from the receiver tank 45 back into the compressor 15 to cool the compressor 15. The refrigerant is injected into the compressor 15 at a point in its compression stroke between the inlet 35 and outlet 40 to assure that the liquid leaving the receiver tank 45 flashes to vapor before it enters the compressor 15.

The line connecting the receiver tank 45 to the injection point of the compressor 15 includes a liquid injection solenoid 195 (LIS) and a liquid injection check valve 200 (LICV). The LICV 200 prevents reverse flow out of the compressor 15 and into the receiver tank 45 under operating conditions when the receiver tank 45 is at a lower pressure than the refrigerant at the injection point.

The LIS 195 is an orificed solenoid that is operated by the controller in response to a high compressor temperature. The LIS 195 allows for the admission of cold refrigerant vapor into the compressor 15 for cooling purposes.

During modes in which the condenser 20 is idle, it is desirable to evacuate the refrigerant from the condenser 20 so that it may be used in the system 10. The present system 10 includes a purge solenoid 205 (PS) and a purge check valve 210 (PCV) disposed within a line that interconnects the outlet of the condenser 20 and the accumulator tank 55. The purge check valve 210 prevents reverse flow of refrigerant from the accumulator tank 55 into the condenser 20.

The purge solenoid 205 opens in conjunction with the closure of the condenser inlet solenoid 95 to evacuate the condenser 20. When the purge solenoid 205 is open, the high-pressure liquid line exiting the condenser 20 is in fluid communication with the suction line entering the accumulator tank 55. The purge solenoid remains 205 open throughout operation in modes in which the condenser 20 is idle. While the purge solenoid 205 remains open throughout operation, it is generally effective only during the transient period as the system 10 switches between modes.

When the unit is offline, the receiver tank 45 pressure is reduced by bleeding refrigerant through a receiver tank check valve 215 (RTCV) that interconnects the receiver tank 45 and the compressor outlet 40.

In addition to the aforementioned hot gas bypass system, the system 10 includes two other systems that are operable to protect the compressor 15 against low suction pressure.

In the first system, the controller reduces the speed of the compressor 15 to reduce the system capacity. This can be done by slowing the engine or motor that drives the compressor 15. In the second system, the speed of the fans moving air through the evaporators 25, 30 is increased to increase the effectiveness of the evaporators 25, 30. This has the desirable effect of increasing the suction pressure at the compressor inlet 35. Furthermore, the three methods described herein can be used in combination to enhance their effectiveness.

During the transient period when the system is switched from one mode to another it is possible for several operating parameters to stray out of their desired ranges. In many cases this could result in a system shut down or other undesirable action. One particularly troublesome transition is one that involves transitioning an evaporator 25, 30 from cooling to heating. To reduce the likelihood of unwanted shut down, the present system pre-cools the compressor 15 and pre-heats the evaporator 25, 30 before switching to the inverted heating mode.

To pre-cool the compressor 15, the purge solenoid 205 is open to admit cool liquid refrigerant into the accumulator tank 45, thereby lowering the temperature of the refrigerant entering the compressor 15, thus cooling the compressor 15. Alternatively, the liquid injection solenoid 195 is open. This allows for a flow of cold refrigerant from the receiver tank 45 to the compressor 15 to pre-cooling the compressor 15.

To preheat the evaporator 25, 30, the system maintains a flow path between the evaporator 25, 30 and the suction line. During the transition to one of the configurations in which an evaporator 25, 30 provides heating or acts as a condenser, hot refrigerant is cycled through the evaporator 25, 30. The CIS 95 is closed to redirect refrigerant from the condenser to the evaporator or evaporators 25, 30. During a predetermined transition period (e.g., two minutes) the SLS 140 remains open to allow hot refrigerant to pass through the evaporators 25, 30 and back into the accumulator tank 55 rather than to an evaporator 25, 30 where the refrigerant would be evaporated. Thus, the hot refrigerant cycles only through the compressor 15 and any evaporators 25, 30 operating in a heating mode for a predetermined time period to preheat the evaporators 25, 30. In another construction, an electrical heating element is positioned adjacent the evaporator 25, 30. The electrical heating element operates to preheat the evaporator 25, 30.

It should be noted that the term “refrigerant” as used herein encompasses any fluid that can be used as a working fluid (e.g., ammonia, freon, R-12, etc.).

Furthermore, the drawings illustrate several configurations of the system 10 but by no means illustrate all possible configurations. For example, FIG. 3 illustrates a heat/cool mode. It should be clear that the system 10 is capable of operating in a cool/heat mode wherein the cooling and heating regions are reversed. Therefore, the invention should not be limited to the modes described herein.

Although the invention has been described in detail with reference to certain preferred embodiments, variations and modifications exist within the scope and spirit of the invention as described and defined in the following claims.

What is claimed is:

1. A dual-zone temperature control system operable to control the temperature in a first and second compartment, the system comprising:
a scroll compressor operable to compress a flow of fluid;
first and second heat exchangers each of which is operable to control the temperature within one of the first and second compartments, the first heat exchanger positioned adjacent the first compartment and the second heat exchanger positioned adjacent the second compartment;
a condenser selectively receiving the flow of fluid, the condenser operable to cool the flow of fluid; and
a flow control system operable to selectively direct the flow of fluid to the condenser or to bypass the condenser such that the first and second heat exchangers operate to maintain their respective compartments within a first and second temperature range, wherein the flow control system includes a variable flow restriction positioned to increase a compressor discharge pressure when the flow of fluid bypasses the condenser.

2. The system of claim 1, wherein the first and second compartments are mobile.

3. The system of claim 1, wherein the compressor includes a suction side having a suction pressure and a discharge side having a discharge pressure, and wherein a valve interconnects the suction side and the discharge side to maintain the ratio of the discharge pressure to the suction pressure below a predetermined value.

4. The system of claim 3, wherein the valve is a solenoid controlled valve.

5. The system of claim 4, wherein the valve further includes an orifice.

6. The system of claim 1, wherein the compressor includes a suction side having a suction pressure and a discharge side, and wherein a valve interconnects the suction side and the discharge side to maintain the suction pressure above a predetermined value.

7. The system of claim 1, further comprising one of an electric motor and an engine providing power to operate the compressor.

8. The system of claim 7, wherein the compressor includes a suction side having a suction pressure and wherein the power supplied to the compressor is reduced in response to a suction pressure below a predetermined value.

9. The system of claim 1, wherein the first and second heat exchangers include first and second fans operable at a speed to improve the effectiveness of the heat exchangers, and wherein the compressor includes a suction side having a suction pressure and wherein the fan speed is increased to increase the suction pressure.

10. The system of claim 1, wherein the compressor has an inlet, an outlet and a compressor stroke therebetween, the outlet discharging the flow of fluid at a discharge temperature, and wherein cool fluid is injected into the compressor in the compressor stroke between the inlet and the outlet to reduce the discharge temperature.

11. The system of claim 1, wherein the flow of fluid is directed to the condenser when neither the first and second compartments require heating.

12. A multi-zone temperature control system operable to control the temperature within a plurality of compartments, the system comprising:
a scroll compressor operable at a speed to compress a flow of fluid and discharge the fluid at a compressor discharge temperature;
a condenser, operable to cool the flow of fluid;
a plurality of heat exchangers, each heat exchanger associated with one of the plurality of compartments and operable to maintain the temperature of the compartment within a desired range;
a plurality of valves, operable to direct and vary the amount of the flow of fluid from the compressor to the condenser and the plurality of heat exchangers, the valves being configurable to allow each of the heat exchangers to heat or cool their associated compartment, at least one of the plurality of valves including a variable flow restriction and positioned to increase the compressor discharge temperature when at least one of the heat exchangers is heating its associated compartment; and
a controller operable to control the valves to maintain the temperature of each compartment within its desired range.

13. The system of claim 12, wherein the valves are operable to configure each heat exchanger to operate in a heat mode to heat their respective compartments, a cool mode to cool their respective compartments, and a null mode in which the compartment temperature is within the desired range.

14. The system of claim 13, wherein the flow of fluid exits the compressor and flows through the condenser only if each heat exchanger is operating in cool mode or null mode.

15. The system of claim 13, wherein the heat exchangers that are operating in heat mode receive the flow of fluid from the compressor and cool the flow of fluid before it is redirected to the heat exchangers operating in cool mode.

16. The system of claim 12, wherein the plurality of compartments are mobile.

17. The system of claim 12, wherein the compressor further includes an inlet operating at an inlet pressure and an outlet operating at an outlet pressure, and wherein the system further comprises a bypass flow path and a valve interconnecting the inlet and the outlet, and wherein the valve is operable to maintain the ratio of the outlet pressure to the inlet pressure below a predetermined value.

18. The system of claim 17, wherein the valve is a solenoid valve containing a flow orifice.

19. The system of claim 12, wherein the compressor further includes an inlet operating at an inlet pressure and an outlet, and wherein the system further comprises a bypass flow path and a valve interconnecting the inlet and the outlet, and wherein the valve is operable to maintain the inlet pressure above a predetermined value.

20. The system of claim 12, wherein the compressor further includes an inlet operating at an inlet pressure and wherein the controller is operable to reduce the speed of the compressor in response to an inlet pressure below a predetermined value.

21. The system of claim 12, further comprising a plurality of fans, each fan operatively associated with one of the heat exchangers, each of the fans operating at a speed.

22. The system of claim 21, wherein the compressor further includes an inlet operating at an inlet pressure and wherein the controller is operable to increase the speed of the fans in response to an inlet pressure below a predetermined value.

23. The system of claim 12, wherein the compressor operates through a compressor stroke, the flow of fluid entering the compressor at an inlet at the beginning of the stroke and exiting the compressor at an outlet at the end of the stroke, the exiting flow of fluid having an exit temperature, and wherein the compressor further includes an injection port in fluid communication with the flow of fluid between the inlet at the beginning of the stroke and the outlet at the end of the stroke.

24. The system of claim 23, wherein the controller operates a valve to inject a cool fluid into the injection port in response to the exit temperature exceeding a predetermined value.

25. The system of claim 23, further comprising a solenoid operated valve operable to admit a flow of fluid from the condenser to the compressor inlet.
